(19) United States
(12) Patent Application Publication
(10) Pub. No.: US 2026/0236462 A1
(43) Pub. Date: Aug. 13, 2026

(54) ENRICHING TECHNICAL CONTENT FOR USE WITH RAG-BASED LLMS

(71) Applicant: International Business Machines Corporation, Armonk, NY (US)

(72) Inventors: Colton Jarrett COX, Wappingers Falls, NY (US); Arielle Micaela GOLDBERG, Blue Bell, PA (US); Justin Paul LARGO, Raleigh, NC (US); Jeffrey BISTI, New Paltz, NY (US)

(21) Appl. No.: 19/050,869

(22) Filed: Feb. 11, 2025

(51) Int. Cl. G06F 16/2452; G06F 16/242; G06N 3/0455

(52) U.S. Cl. CPC G06F 16/24522; G06F 16/243; G06N 3/0455

(57) ABSTRACT

Method and apparatus for improving documents for ingestion by LLMs. Certain types of documents, such as technical documents, are not inherently structured to meet the criteria of a predefined chunking strategy of various LLM models. Due to this, model accuracy can be negatively impacted, increasing the likelihood of hallucinations when an LLM is given a technical document (or the like) to analyze.

### BACKGROUND

The present invention relates to large language models (LLMs), and more specifically, toward textual content ingested by LLMs. Chunking is a method used by LLMs for consuming data. Chunking refers to breaking large text or data into smaller, manageable pieces (chunks) for understanding and processing. Each chunk can be processed independently or sequentially, and they may have overlapping segments to maintain continuity. This technique can help preserve the context and coherence of the input, especially for inputs that exceed the model’s token limit.

### SUMMARY

According to one embodiment, a method includes: receiving input content from a user, wherein the input content comprises natural language text describing technical content; determining a search-ability score of the input content for future use in AI models by: predicting, using a first LLM, a question which the input content may be used to answer in the future; generating, using a second LLM, an answer to the question based on the input content; and generating, using a third LLM, the search-ability score based on the answer; and generating a suggestion to rephrase the input content based on the search-ability score.

According to another embodiment, a computer system for generating organized technical content, the computer system comprising: one or more computer processors; one or more computer readable storage media; and program instructions stored on the computer readable storage media for execution by at least one of the one or more processors, the program instructions comprising processors configured to perform operations including : receiving input content from a user, wherein the input content comprises natural language text describing technical content; determining a search-ability score of the input content for future use in AI models by: predicting, using a first LLM, a question which the input content may be used to answer in the future; and generating, using a second LLM, an answer to the question based on the input content; generating, using a third LLM, the search-ability score based on the answer; and generating a suggestion to rephrase the input content based on the search-ability score.

A computer program product for debris particle arrangement, the computer program product including : a computer-readable storage medium having computer-readable program code embodied therewith, the computer-readable program code executable by one or more computer processors configured to perform operations including: receiving input content from a user, wherein the input content comprises natural language text describing technical content; determining a search-ability score of the input content for future use in AI models by: predicting, using a first LLM, a question which the input content may be used to answer in the future; generating, using a second LLM, an answer to the question based on the input content; and generating, using a third LLM, the search-ability score based on the answer; and generating a suggestion to rephrase the input content based on the search-ability score.

### BRIEF DESCRIPTION OF THE DRAWINGS

FIG. 1 illustrates a functional block diagram of a networked environment, in accordance with an example embodiment of the present invention.

FIG. 2 illustrates an AI system, according to some embodiments.

FIG. 3 illustrates a flow diagram of user interaction with the AI system according to some embodiments.

FIG. 4 illustrates the LLM program of the above mentioned AI system, according to some embodiments.

FIG. 5 illustrates a flow diagram of the above mentioned LLM program, according to some embodiments.

### DETAILED DESCRIPTION

Embodiments herein relate to improving documents for ingestion by LLMs. Certain types of documents, such as technical documents, are not inherently structured to meet the criteria of a predefined chunking strategy of various LLM models. Due to this, model accuracy can be negatively impacted, increasing the likelihood of hallucinations when an LLM is given a technical document (or the like) to analyze.

Embodiments herein relate to improvements for providing LLMs with technical content, such that the LLM can interpret the information and provide accurate results with a lower likelihood of hallucinations.

As a user writes a technical document, in one embodiment an AI system evaluates the content as it is written. A series of LLMs are invoked to generate relevant prompts, responses, and evaluations of the responses relative to the source content. The AI system can provide recommend changes to the source content that would optimize the source content for analysis by LLMs.

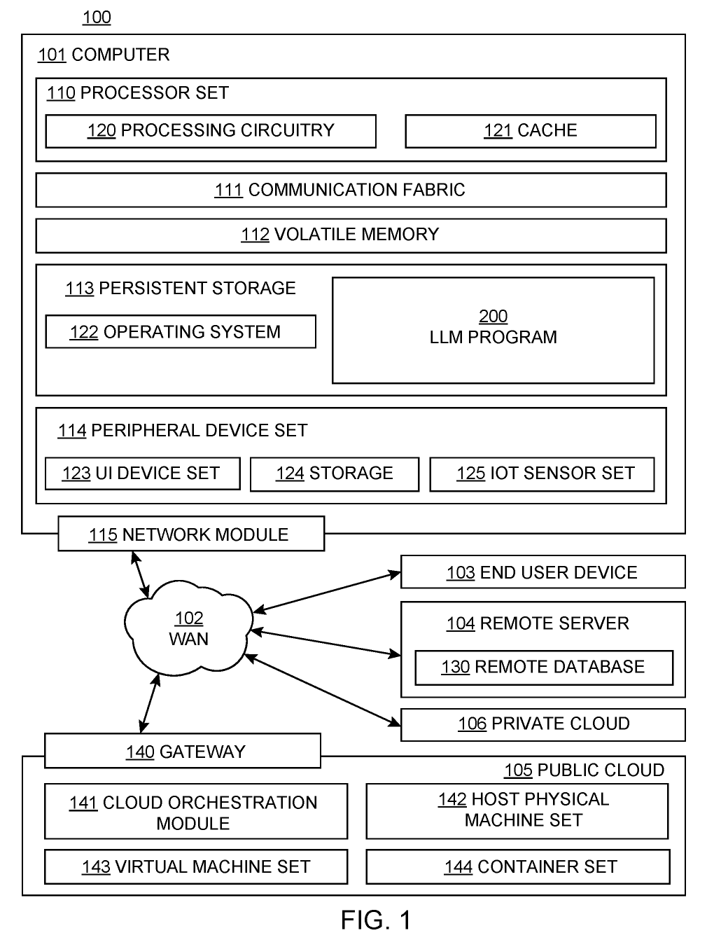

With reference now to FIG. 1.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the LLM program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

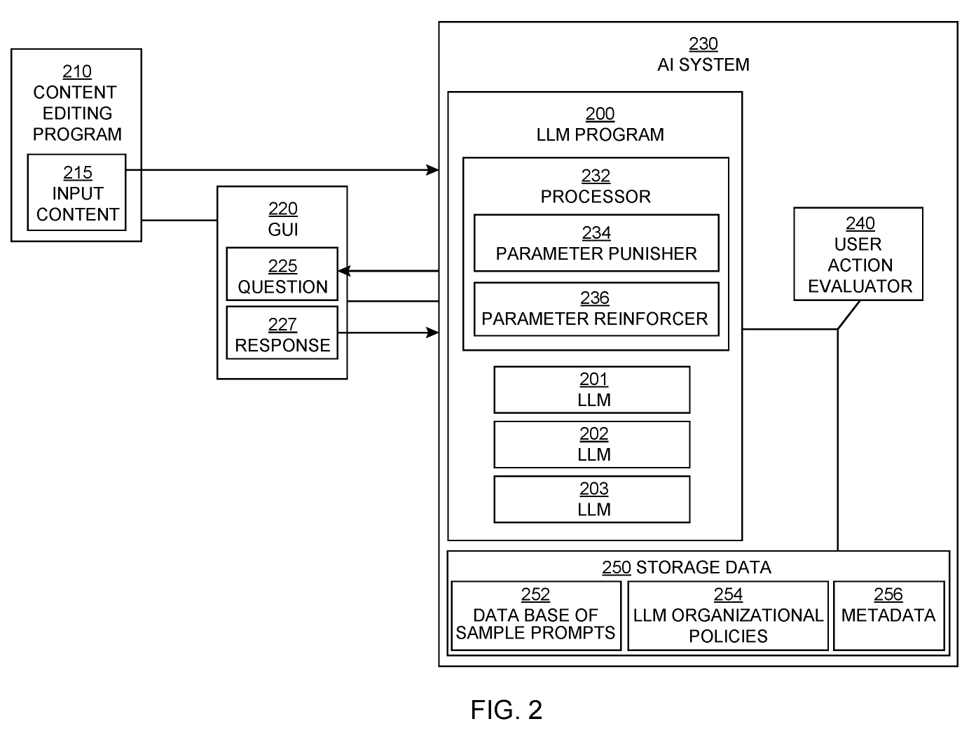

FIG. 2 illustrates an AI system 230 that facilitates creating a technical document that is more searchable for future use in RAG systems. The content editing program 210 supplies the AI system 230 with input content 215.

Within the AI system 230 is an LLM program 200. The LLM program 280 receives the input content 215. Using a plurality of LLMs (the LLM 201, 202 and 203), the LLM program 200 helps a user create a technical document that can be more easily chunked by LLMs implemented in RAG systems.

The LLM 201 ingests the input content 215 from the content editing program 210 and predicts a question that a future LLM in a RAG system may be provided with, based on the contents of the input content 215. For example, if the input content states “the algorithm x is a step by step process to solve a problem y” the LLM 201 might predict a question as “to solve the problem y, is there an algorithm a user may use?” The LLM program 200 then takes this question provided by the LLM 201 and provides it to the LLM 202.

The LLM 202 receives the question generated by LLM 201 and answers it. The LLM 203 evaluates the answer in the context of the input content 215 and judges whether or not the answer is adequate given the context of the input content 215.

The LLM 203 generates a search ability score of the input content. The search-ability score can be based on the question and answer combination provided by the LLM 201 and the LLM 202, as well as information from the storage data 250. The storage data 250 includes a database of sample prompts 252, LLM organizational policies 254, and general meta data 256. If the search-ability score determined by the LLM 203 falls below a certain threshold, the user action evaluator 240 provides a question 225 to a user of the content editing program 210, facilitated by a GUI 220.

The user action evaluator 240 generates the question 225 which is provided to the user if it is determined, by the LLM 203, that the input content 215 has a search-ability score below a predetermined threshold. The question 225 can be a suggestion for rephrasing the content, to which the user can provide a response 227 explaining why rephrasing would not work, or why rephrasing could work, among other things. For example, the user might not want to rephrase content if the AI system 230 suggests using a “simpler vocabulary term,” if the term in question is a key component of the input content. The user can explain this decision in the response 227. The question 225 can also ask the user to clarify the context of the input content 215, to which the response 227 can be the context. The question 225 can also request the user provide more background information in the input content 215, to which the user can provide a response 227 stating that more background information is not possible, or an affirmative, providing more background information in the input content 215, among other things. The above examples of questions and responses are non-limiting.

After the question 225 and response 227 interaction between the user of the content editing program 210 and the AI system 230, the processor 232 of the LLM program 200 updates accordingly. For example, a parameter punisher 234 can punish parameters of the LLMs used in the LLM program that prompted the user action evaluator 240 to provide a suggestion within the question 225 that was rejected, and a parameter reinforcer 236 can reinforce the parameters of the LLM program that prompted the user action evaluator 240 to provide a suggestion within the question 225 that was accepted. The parameter punisher 234 and the parameter reinforcer 236 may be software programs within the AI system 230.

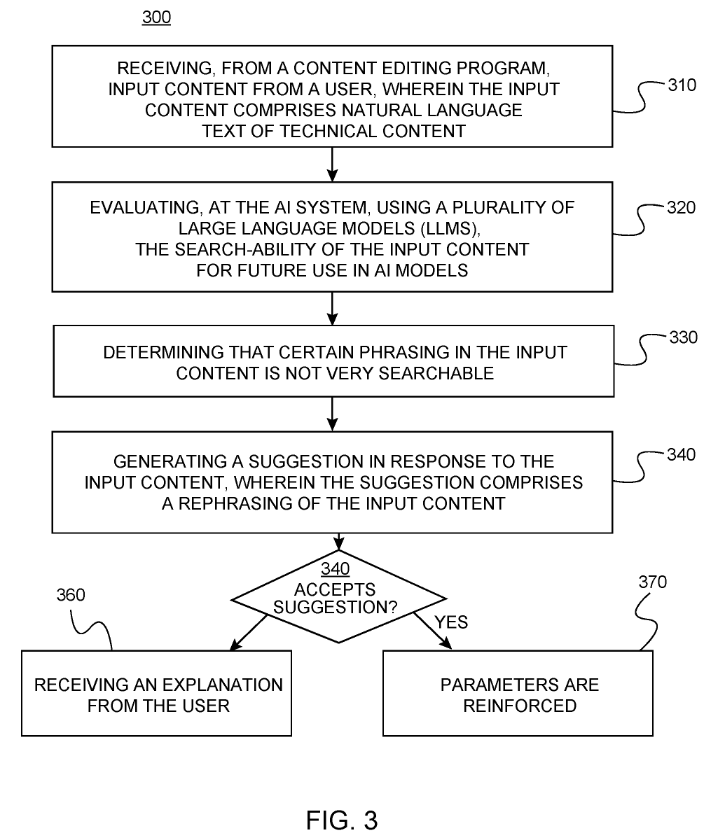

FIG. 3 illustrates a flowchart 300 of the workflow between the content editing program 210 and the AI system 230.

As mentioned above, chunking is a preprocessing technique used in LLMs to better ingest content for understanding. However, when an LLM ingests technical content as an input, the technical content is not always well equipped for chunking, causing the LLM to produce invalid results. This is because compared to other content, technical content can rely on complex interdependencies, precise terminology, and logical structures that span multiple sections of the document that is used as input content. When the input content is broken into chunks, maintaining relationships between ideas and ensuring accurate context can become difficult if critical references or definitions are split across chunks. Additionally, the overlapping of segments used as a chunking technique to preserve continuity, can actually introduce redundancy or inconsistencies in some technical content, causing an LLM to struggle to reassemble the fragmented information coherently. Therefore, the technical content that is input content is not always well equipped for chunking.

However, this flowchart 300 illustrates a workflow that allows a user to create technical content that can be well equipped for chunking.

At block 310 the AI system receives the input content 210 from the content editing system. The input content can be natural language text describing technical content. The content editing program 210 can be a digital tool designed to help users create, edit, and format text-based documents. Such programs can provide a user-friendly interface and can include features to check spelling, check grammar, or provide formatting options. Some content editing programs support collaboration allowing multiple users to worn on the same document simultaneously.

The input content 215, or technical content written into the content editing program can be received in real time by the AI system 230, as a user writes.

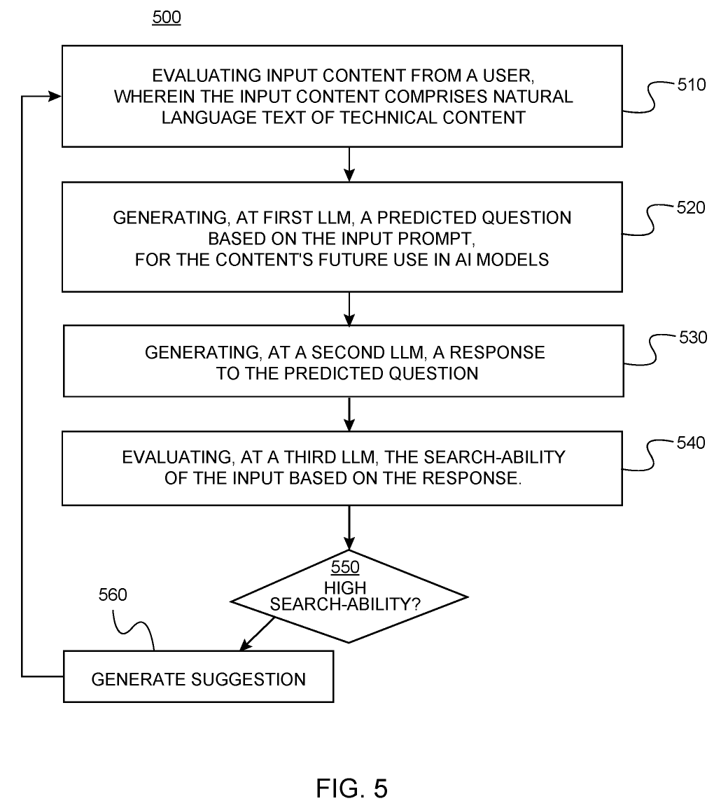

At block 320 the LLM program 200 evaluates the search-ability of the input content 215 using the LLM 201, the LLM 202 and the LLM 203. As mentioned in FIG. 2, the LLM 201, 202 and 203 perform a series of steps that are interconnected to evaluate the search-ability of the input content 215. The LLM 201 receives the input content 215 and predicts a question that may be asked to a future LLM, where the future LLM would use the input content 215 to answer the question in a RAG system. For example, the LLM 201 may predict that it is likely that a future user could ask a future LLM “what is a k-nearest neighbor’s algorithm?” if the LLM 201 picks up that the input content pertains to k- nearest neighbor’s algorithms. After the LLM 201 predicts a question, the LLM 202 would then receive the generated question, and provide an answer using the input content 215, or other stored data, to generate its answer. The LLM 203 evaluates the response from the LLM 202, and using a combination of the storage data 250, the input content 215, the question generated by the LLM 201 and the response to the question provided by the LLM 202, the LLM 203 generates a search-ability score for the input content 215. FIG. 5 provides more detail on how the search-ability score is determined.

Within the storage data 250, the database of sample prompts 252 is a collection of examples designed to guide the LLM 201 to generate its own prompts or questions. The entries of the database can include prompts or questions associated with context and desired outputs or responses. The example prompts in the database of sample prompts 252 can cover a range of topics, writing styles, and question types, ensuring the LLM 201 can generate a probable prompt or question that is likely to be paired with the input content 215. The database of sample prompts 252 can serve as a reference or training resource for the LLM 201, heling the LLM 201 identify patterns, infer structures, and adapt accordingly to the input content 215.

Also within the storage data, the LLM organizational policies 254 can include guidelines or rules that govern how LLMs are used, trained and deployed. These policies can help ensure ethical usage, help protect sensitive data, and align the LLM program’s 200 applications with certain organizational or legal values. This can include guidelines in acceptable content, prohibitions against generating harmful or misleading information, and restrictions on processing personal or confidential data, among other things.

Using the LLM organizational policies 254 at the user action evaluator 240 and the LLM program 200 ensures that sample prompts and answers generated by the LLM program 200 align with common ethical standards, avoid bias, and meet expectations of LLMs for future use. The LLM organizational policies 254 help guide the LLM program 200 in creating accurate content that is appropriate and checked for harmful or sensitive information.

Additionally, the metadata 256 of the storage data 250 can include any supplementary information that provides context about the data or tasks the LLM program 200 processes. This can include details such as the source or the input content 215, or other data used, the language or domain of the content data, the intended audience, the tone or complexity of the material, etc. The metadata 256 can help the LLM program 200 understand nuances, and tailor responses, ensuring outputs are relevant and appropriate for certain content. For example, metadata 256 can indicate whether the task for the LLM program 200 involves knowledge of chemistry, physics, electrical engineering, etc.

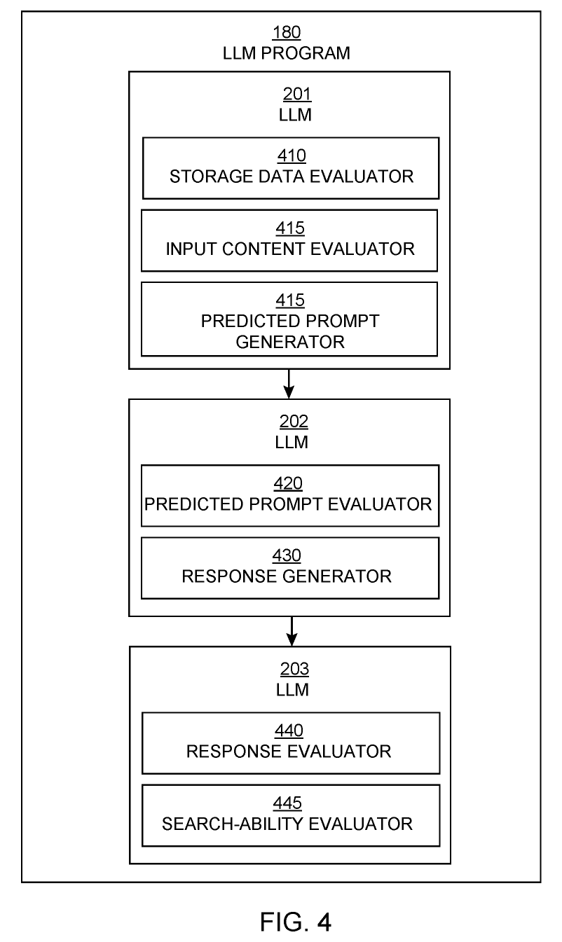

More details on the LLM program 200, including the LLM 201, 202 and 203, are included in FIGS. 4 and 5.

At block 330 the LLM 203 determines that certain phrasing of the input content is not sufficiently searchable based on the search-ability score from block 320 falling below a predetermined threshold. As discussed, the LLM 203 evaluates the question generated by the LLM 201, and the response provided by the LLM 202, in the context of the input content 215. The LLM 203 acts as a judge and evaluates the outputs of the LLM 201 and 202 against predefined criteria or standards found in the storage data 250. Such criteria can include accuracy, coherence, relevance, or ethical appropriateness, among other things. The LLM 203 can assign a search-ability level of the input content based on these criteria, identifying areas where the output of the LLM 201 or LLM 202 fall short.

Once it is determined that the input content 215 does not have a sufficiently high score, a suggestion for the user can be generated.

At block 340 the user action evaluator 240 generates a suggestion for the user to alter the input content to make it more searchable. The user action evaluator 240 can use the search-ability score generated by the LLM 203, as well as the reasoning for the generated search-ability score, to provide suggestions or questions to the user, prompting the user to change the input content 215. For example, if the search-ability score is determined to fall below the predetermined threshold due to the input content’s 215 lack of clarity, the user action evaluator 240 can generate the question 225 to ask if the user can provide definitions for certain terms from the input content. Additionally, the user action evaluator 240 can find that a search-ability score falling below a predetermined threshold could be due to the content being overly complex for a general audience. For example, if the input content is pertaining to machine learning in a way that the LLM 203 deems is not very searchable, the user action evaluator 240 may generate a question 225 suggesting the user replace terms such as “gradient descent optimization” with “a step-by-step process to adjust and improve model predictions” which is a phrase deemed as “more searchable” for LLMs due to the phrase’s generality.

As mentioned in FIG. 2, the question 225 can be asked via the GUI 220.

At block 350 the user reads the suggestion provided by the user action evaluator 250, and either accepts and implements the suggestion, or does not, providing the AI system 230 with a response 227 as to why they did not accept the suggestion. In some embodiments, the user can also provide a response 227 as to why they did accept the suggestion(s). In other embodiments, the user simply making changes to the document without providing an explicit acceptance explanation to the GUI can be interpreted as the user accepting the suggestion found in the provided question 225.

At block 360 the user would have rejected the suggestion, and the AI system 230 receives the explanation response from the user. Using the response 227 the processor 232 adjusts the parameters of the LLM program 200 using the parameter punisher 234. By receiving this feedback from the user, the parameter punisher 234 can alter the parameters of the LLM program to better understand the preferences or constraints of the input content 215, and how to then make a different suggestion to better equip the input content 215 for chunking.

The parameter punisher 234 can update the weighing of certain criteria, after considering the response 227, such as prioritizing consistency over simplification, importance of tone in the document, etc. For example, if the response 227 indicates that the question 225, which asks to simplify the technical jargon of the text, is actually not appropriate because the intended audience of the input content 215 is domain experts, the LLM program 200 can flag similar contexts in the future and suggest refinements that retain technical precision, but still offer improvements for chunking. This adjustment in the parameters can help the AI system 230 align its recommendations to fit the goals of a user, improving the quality and usability of the question 225 it generates.

At block 370 the user accepts the suggestion, and the parameter reinforcer 236 of the processor 232 of the LLM program 200, reinforces the parameters of the AI system 230 that led to the generation of the question 225. The parameter reinforcer 236 provides positive reinforcement to the mechanisms of the LLM program 200 that enabled the accepted recommendation.

For example, if a user accepts a recommendation provided in the question 225 that states “can you replace the phrase ‘due to the fact that’ with ‘because’,” the parameter reinforcer 236 can use this feedback to encourage the parameters to use similar approaches when analyzing and suggesting content in the future. This feedback loop can strengthen the model’s ability to generate high-value recommendations that consistently meet user expectations.

FIG. 4 illustrates the LLM program 200 in more detail. The LLM 201 includes a storage data evaluator 410, an input content evaluator 415, and a predicted prompt generator 417. As mentioned in FIGS. 2 and 3, the LLM 201 produces a question, or prompt. The question or prompt is meant to be a predicted question or prompt that a future LLM might be presented with, where the future LLM may refer to the input content 215 as a means for answering the question, typically in a RAG system.

To generate the question at the predicted prompt generator 417, the LLM 201 uses the storage data evaluator 410 and input content evaluator 415. The storage data evaluator 410 evaluates the data from the storage data 250, including the database of sample prompts, the LLM organizational policies 254, and the metadata 256. The analyzed storage data 250 can serve as references to understand the nature of potential queries, the style of expected outputs, and the ethical or contextual considerations future LLMs may use. For example, analyzing the database of sample prompts 252 can provide the LLM 201 with examples of ways of framing questions effectively. Analyzing the metadata 256 can help the LLM 201 refine the scope and tone of a probable question, and the analyzing the LLM organizational policies 254 can ensure the output of the LLM 201 are aligned with certain standards for accuracy, fairness, relevance, etc. Synthesizing the information from the storage data 250 allows the LLM 201 to have an understanding of the type of queries future models may encounter.

The input content evaluator 415 analyzes the input content 215 for key themes, contexts and purpose. It can examine linguistic cues, domain-specific terminology, and logical flow of the information, among other things, to determine ways the content may be utilized in future scenarios. This analysis can help the LLM 201 infer potential use cases such as whether the content could support educational purposes, technical problem solving, etc.

To generate the predicted question, the predicted prompt generator 417 combines insights from both the storage data evaluator 410, and the input content evaluator 415. The predicted prompt generator 417 can anticipate scenarios where the input content 215 might be relevant, and formulates a question to prompt a future LLM to engage with the material effectively. For example, if the input content is a detailed explanation of a technical process, the predicted question might be “How can this process be adapted to address challenges in [a certain field]?” This question integrates the content into a meaningful context, and also aligns with the patterns and standards established by the storage data.

The LLM 202 receives the generated predicted question from the LLM 201. The LLM 202 contains a predicted prompt evaluator 420, and a response generator 420 to output an answer to the predicted question.

The predicted prompt evaluator 420 analyzes the predicted question generated by the LLM 201. The predicted prompt evaluator 420 analyzes the question’s intent, key terms, and level of detail requested for an answer. The predicted prompt evaluator 420 determines whether the question seeks factual information, an explanation, a created output, etc. then identifies relevant segments of the input content that can serve as a basis for constructing the answer. For example, if the input content includes a technical description of a process and the question asks “what are the key steps in the process?” the predicted prompt evaluator 420 isolates the relevant information from the input content 215 to form a coherent and concise response.

The response generator 430 takes into consideration the evaluations from the predicted prompt evaluator 420, and also references the storage data 250, for similar reasons as the LLM 201. Using this combination of data, the response generator 430 outputs a response to the question provided by the LLM 201.

The LLM 203 acts as a judge, and evaluates the quality of the response from the LLM 201. Using this evaluation, the LLM 203 determines a search-ability score for the input content 215. If the search-ability score falls below a predetermined threshold, the LLM 203 initiates the generation of a suggestion to change the input content 215.

The LLM 203 uses a response evaluator 440 to determine whether or not the response encompasses qualities of a response that a future user would determine useful. This is done by comparing the given response to the responses provided in the storage data 250. The nature of the comparison and evaluation is done in a similar manner as the comparison and evaluation process described for the LLM 201 and the LLM 202.

After evaluating the response, the search-ability evaluator 445 generates a search-ability score for the input content 215. The search-ability score can represent how effectively the input content 215 can be used to generate accurate and relevant responses to questions in future use cases. The search-ability evaluator 445 uses several factors to determine how searchable the input content 215 is, such as the clarity, structure, and how easily understood the response generated by the LLM 202 is, which is evaluated by the response evaluator 440. Using the data from the response evaluator 440, the search-ability evaluator 445 generates a search-ability score for the input content 215. If the search-ability score falls below a certain predetermined threshold, as discussed in FIG. 3, the user action evaluator 240 is triggered to generate a question 225 to prompt editing the input content 215 so that upon a next review, the search-ability score is more likely to be above the predetermined threshold.

FIG. 5 illustrates a flow diagram 500 of the LLM program 200, providing a more detailed explanation of what occurs in block 320 of FIG. 3.

At block 510, the input content evaluator 415 evaluates the input content 215, wherein the input content comprises natural language text describing technical content. As discussed in FIG. 2, the input content 215 may be written content pertaining to technology. As discussed in FIG. 4, the input content evaluator 415 considers the input content 215, as part of the data the LLM 201 uses to generate a predicted question. The predicted question refers to a probable question a future LLM may be presented with where it would refer to the input content 215 to answer the question.

At block 520 the predicted prompt generator 417 of the LLM 201 generates the predicted question based on the input prompt, for the input content’s 215 future use in AI models. As discussed in FIG. 4, the predicted prompt generator uses information from the storage data evaluator 410 and the input content evaluator 417, to generate a prompt that is likely to be fed to LLMs in the future, where the LLMs are likely to use the input content 215 to answer the prompt. The components of the LLM 201 may use a variety of methods to analyze the storage data and input content.

At block 530 the LLM 202 generates a response to the predicted question from the LLM 201. As discussed in FIG. 4, the predicted prompt evaluator 440 evaluates the prompt provided by the LLM 201, as well as the storage data 250. After this evaluation, the response generator 430 responds to the prompt as a future LLM presented with the question is likely to respond.

At block 540 the LLM 203 evaluates the search-ability of the input content 215. Also discussed in FIG. 4, the LLM 203 uses a response evaluator 440 and a search-ability evaluator 445 to determine a search-ability level of the input content 215. The LLM 203 evaluates a combination of the response provided by the LLM 202, the question generated by the LLM 201, the input content 215 itself, and the storage date 250, among other things, to determine the search-ability level or score of the input content 215.

At decision block 550, it is determined whether or not the search-ability score provided by the LLM 203 meets a predetermined threshold. Also discussed in FIG. 4, the search-ability score measures the effectiveness of the input content 215, and how easily it can be chucked by LLMs that may use it as a data source in the future. The data from the response evaluator 440 and the search-ability evaluator contribute to the generation of the search-ability score.

At block 560 the user action evaluator 240 is triggered if the search-ability score falls below a predetermined threshold. As discussed in FIG. 3, the user action evaluator 240 considers a variety of factors, such as what caused the search-ability score to fall below a predetermined threshold, and generates a question 225 for the user to either accept or reject.

While the foregoing is directed to embodiments of the present invention, other and further embodiments of the invention may be devised without departing from the basic scope thereof, and the scope thereof is determined by the claims that follow.

What is claimed is:

1. A method comprising:
receiving input content from a user, wherein the input content comprises natural language text describing technical content;
determining a search-ability score of the input content for future use in AI models by:
predicting, using a first LLM, a question which the input content may be used to answer in the future;
generating, using a second LLM, an answer to the question based on the input content; and
generating, using a third LLM, the search-ability score based on the answer; and
generating a suggestion to rephrase the input content based on the search-ability score.

2. The method of claim 1, further comprising:
receiving a second input content from the user explaining a rejection to the suggestion;
evaluating the second input content; and
generating a second suggestion.

3. The method of claim 1, wherein the question is generated by evaluating the input content .

4. The method of claim 1, wherein the answer is generated using the input content.

5. The method of claim 4 wherein the search-ability score of the input content is generated based on an evaluation of the answer compared against a database of sample prompts and answers.

6. The method of claim 5 further comprising:
the search-ability score falling below a predetermined threshold value; and
generating the suggestion in response to the input content.

7. The method of claim 1, wherein predetermined set of ingestion parameters influence the generation of the suggestion.

8. The method of claim 1 wherein the input content is stored as metadata in a retrieval database.

9. A computer system for generating organized technical content, the computer system comprising:
one or more computer processors;
one or more computer readable storage media; and
program instructions stored on the computer readable storage media for execution by at least one of the one or more processors, the program instructions comprising processors configured to perform operations comprising:
receiving input content from a user, wherein the input content comprises natural language text describing technical content;
determining a search-ability score of the input content for future use in AI models by:
predicting, using a first LLM, a question which the input content may be used to answer in the future;
generating, using a second LLM, an answer to the question based on the input content; and
generating, using a third LLM, the search-ability score based on the answer; and
generating a suggestion to rephrase the input content based on the search-ability score.

10. The system of claim 9, further comprising:
receiving a second input content from the user explaining a rejection to the suggestion;
evaluating the second input content; and
generating a second suggestion.

11. The system of claim 9, wherein the question is generated by evaluating the input content.

12. The system of claim 9, wherein the answer is generated using the input content.

13. The system of claim 12, wherein the search-ability score of the input content is generated based on an evaluation of the answer compared against a database of sample prompts and answers.

14. The system of claim 13 further comprising:
the search-ability score falling below a predetermined threshold value; and
generating the suggestion in response to the input content.

15. The system of claim 9, wherein predetermined set of ingestion parameters influence the generation of the suggestion.

16. The system of claim 9, wherein the input content is stored as metadata in a retrieval database.

17. A computer program product for debris particle arrangement, the computer program product comprising:
a computer-readable storage medium having computer-readable program code embodied therewith, the computer-readable program code executable by one or more computer processors configured to perform operations comprising:
receiving input content from a user, wherein the input content comprises natural language text describing technical content;
determining a search-ability score of the input content for future use in AI models by:
predicting, using a first LLM, a question which the input content may be used to answer in the future;
generating, using a second LLM, an answer to the question based on the input content; and
generating, using a third LLM, the search-ability score based on the answer; and
generating a suggestion to rephrase the input content based on the search-ability score.

18. The computer program product of claim 17, further comprising:
receiving a second input content from the user explaining a rejection to the suggestion;
evaluating the second input content; and
generating a second suggestion.

19. The computer program product of claim 17, wherein the question is generated by evaluating the input content.

20. The computer program product of claim 17, wherein the answer is generated using the input content.
